(19) United States
(12) Patent Application Publication
(10) Pub. No.: US 2012/0027904 A1
(43) Pub. Date: Feb. 2, 2012

(54) COOKING APPLIANCE AND CONTROL METHOD THEREOF

(76) Inventor: Chang-Seob Lim, Seoul (KR)

(21) Appl. No.: 13/263,969

(22) PCT Filed: Sep. 3, 2009
(86) PCT No.: PCT/KR2009/004943

§ 371 Date: Oct. 11, 2011

(30) Foreign Application Priority Data
May 12, 2009 (KR) 10-2009-0041453

(51) Int. Cl. A23L 1/01

(52) U.S. Cl. 426/523

(57) ABSTRACT

A cooking appliance includes a main body having an inner space, the main body defining an outer appearance, a cooktop part disposed on an upper end of the main body to heat a food or a container containing the food disposed on a top surface thereof, an oven part disposed under the cooktop part to cook the food received in the inner space, a manipulation panel including a manipulation part for manipulating operations of the cooktop part and the oven part, and a display part in which cooking by category according to a signal of the manipulation panel is displayed on an upper menu, a lower menu of the upper menu in which a first input signal of a user is inputted is displayed, and an operation of the lower menu in which a second input signal of the user is displayed.

### CROSS-REFERENCE TO RELATED APPLICATIONS

The present application claims priority under 35 U.S.C. 119 and 35 U.S.C. 365 to Korean Patent Application No. 10-2009-0041453 (filed on May 12, 2009), which is hereby incorporated by reference in its entirety.

### BACKGROUND

The present disclosure relates to a cooking appliance and a control method thereof, and more particularly, a cooking appliance having a cooking guide function for guiding a cooking process to a user and a control method thereof.

A cooking appliance is a kind of home appliance which is disposed in a kitchen space to cook a food. According to its function, the cooking appliance may be classified into a microwave oven, an oven, and a range. Also, according to installed positions, the cooking appliance may be classified into a built-in type, a free-stand type, and a wall-mounting type.

The microwave oven is a kitchen appliance in which a high frequency is emitted into an inner space in which a food is disposed to heat the food using the high frequency, thereby cooking the food. The oven is a kitchen appliance in which a food is heated by heat emitted from a heater or burner into an inner space in which the food is placed to cook the food.

The range is a kind of kitchen appliance in which a cooktop for heating a container containing a food or the food to cook the food is disposed above the oven to form one kitchen appliance including the oven and the cooktop. Thus, the range is being spotlighted in recent years because various foods and a large amount of foods can be cooked at the same time.

The built-in type cooking appliance may be received in kitchen furniture disposed in the kitchen space. The free-stand type cooking appliance may be installed at a position desired by a user. The wall-mounting type cooking appliance may be installed on a wall of the kitchen space to perform a hood function for discharging contaminated air generated in the kitchen space to the outside at the same time.

A plurality of heating sources for emitting heat into a cooking space to heat the cooking space are disposed in the cooking appliance. Since the cooking space is heated by heat emitted from the heating sources, the food placed in the cooking space may be heated and cooked.

The cooking appliance may cook the food only when the user inputs cooking information. Here, the cooking appliance may automatically cook the food according to stored data.

### SUMMARY

Embodiments provide a cooking appliance which guides cooking choice of a user.

Embodiments also provide a cooking appliance which is capable of cooking a food in various methods according to a cooking guide function.

Embodiments also provide a cooking appliance which guides cooking choice of a user according to a kind of foods.

In one embodiment, a cooking appliance includes: a main body having an inner space, the main body defining an outer appearance; a cooktop part disposed on an upper end of the main body to heat a food or a container containing the food disposed on a top surface thereof; an oven part disposed under the cooktop part to cook the food received in the inner space; a manipulation panel including a manipulation part for manipulating operations of the cooktop part and the oven part; and a display part in which cooking by category according to a signal of the manipulation panel is displayed on an upper menu, a lower menu of the upper menu in which a first input signal of a user is inputted is displayed, and an operation of the lower menu in which a second input signal of the user is displayed.

In another embodiment, a method of controlling a cooking appliance includes: a first process for determining whether a food exists or detecting a signal by user's selection; a second process for expressing an upper menu by category when the food does not exist or the user's selection is detected in the first process; a third process in which the upper menu expressed in the second process expresses a lower menu by upper menu according to a first input signal; a fourth process in which the lower menu expressed in the third process express a cooking progress according to a second input signal.

The details of one or more embodiments are set forth in the accompanying drawings and the description below. Other features will be apparent from the description and drawings, and from the claims.

### BRIEF DESCRIPTION OF THE DRAWINGS

FIG. 1 is a perspective view illustrating an outer appearance of a cooking appliance according to an embodiment.

FIG. 2 is a view illustrating a main screen of a display part of a cooking appliance according to an embodiment.

FIG. 3 is a view illustrating a display part when a first input signal is inputted into a cooking appliance according to an embodiment.

FIG. 4 is a view illustrating a display part depending on search/input menu selection of a cooking appliance according to an embodiment.

FIG. 5 is a view illustrating a display part depending on bookmark menu selection of a cooking appliance according to an embodiment.

FIG. 6 is a view illustrating a display part depending on upper menu selection for a time in a cooking appliance according to an embodiment.

### DETAILED DESCRIPTION OF THE EMBODIMENTS

Hereinafter, a cooking appliance and a control method thereof according to an embodiment will be described in detail with reference to the accompanying drawings.

The invention may, however, be embodied in many different forms and should not be construed as being limited to the embodiments set forth herein; rather, that alternate embodiments included in other retrogressive inventions or falling within the spirit and scope of the present disclosure can easily be derived through adding, altering, and changing, and will fully convey the concept of the invention to those skilled in the art.

Although specific embodiments are described as an example for convenience of description, the present disclosure is not limited thereto. For example, the embodiments may be applied to various cooking appliances in which a food is directly cooked.

Also, since terms used in the specification or claims are concepts selected for convenience of description, it should be interpreted as meanings suitable for the spirit and scope of the present disclosure in order to most appropriately comprehend technical contents of the present disclosure.

Various heating sources may be used in the cooking appliance according to an embodiment. Hereinafter, a built-in type cooking appliance will be described as an example.

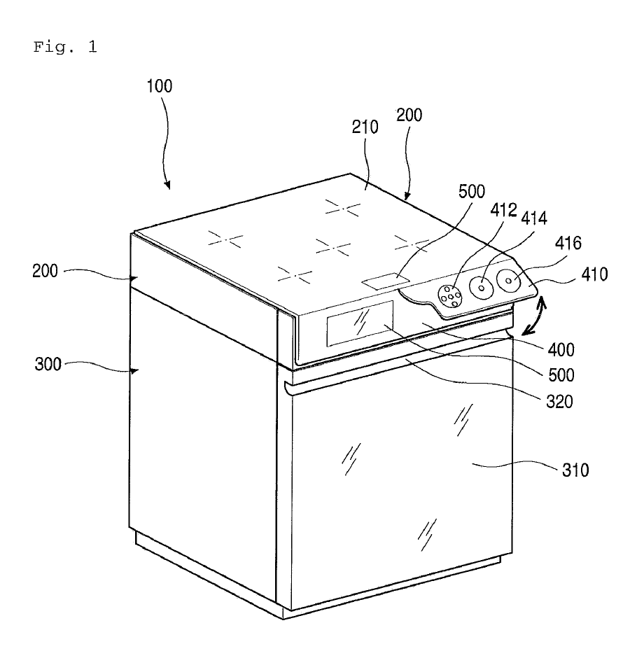

FIG. 1 is a perspective view illustrating an outer appearance of a cooking appliance according to an embodiment.

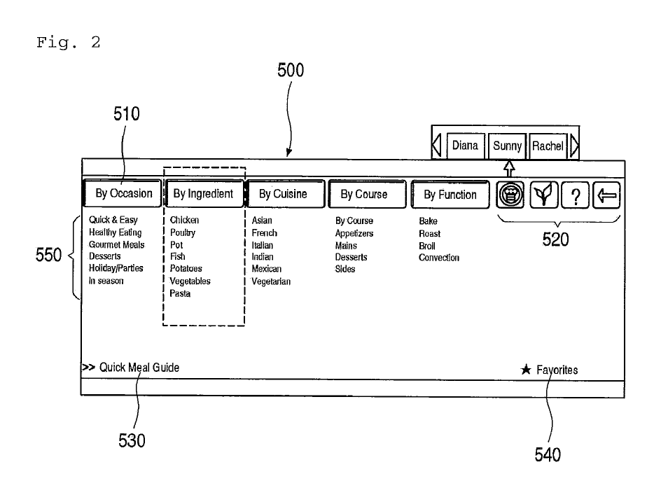

FIG. 2 is a view illustrating a main screen of a display part of a cooking appliance according to an embodiment.

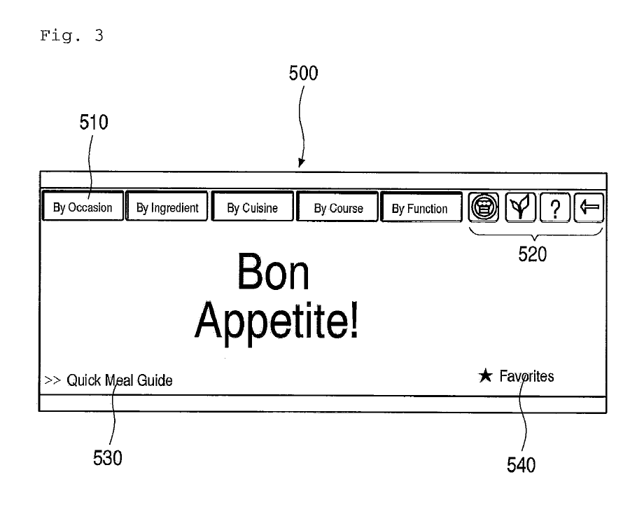

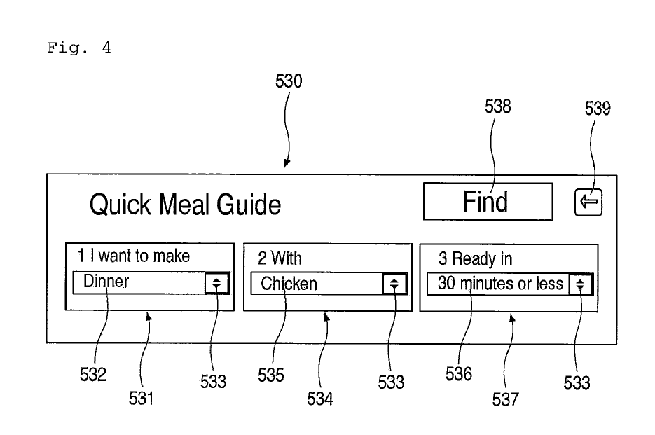

FIG. 3 is a view illustrating a display part when a first input signal is inputted into a cooking appliance according to an embodiment. FIG. 4 is a view illustrating a display part depending on search/input menu selection of a cooking appliance according to an embodiment.

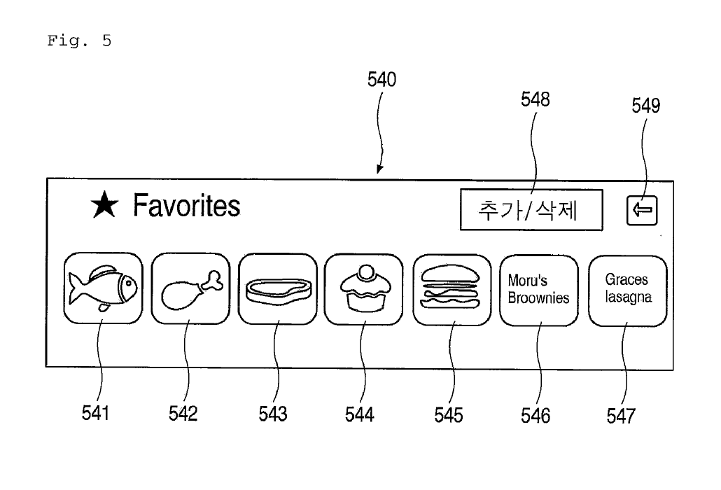

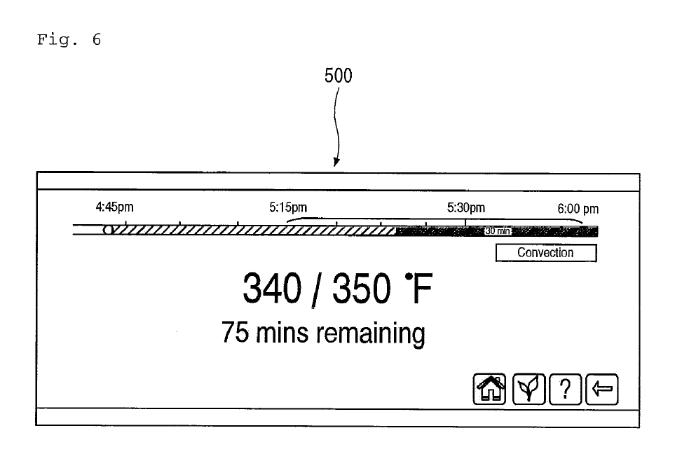

FIG. 5 is a view illustrating a display part depending on bookmark menu selection of a cooking appliance according to an embodiment. FIG. 6 is a view illustrating a display part depending on upper menu selection for a time in a cooking appliance according to an embodiment.

Hereinafter, a cooking appliance and a control method thereof according to an embodiment will be described in detail with reference to the accompanying drawings.

An outer appearance of a cooking appliance according to an embodiment is defined by a main body 100 having an approximately rectangular parallelepiped shape on the whole. A cooktop part 100 in which a food placed on a top surface thereof or a container containing a food is heated to cook the food is disposed at the uppermost position of the main body 100. An oven part 300 receiving the food in an inner space thereof and heating the space in which the food is received using a plurality of heating sources to cook the food is disposed under the cooktop 200.

A drawer part for storing the cooked food in a warm state or heating the food at a low temperature to cook the food is further disposed under the oven part 300.

The cooktop part 200 has an approximately rectangular parallelepiped shape on the whole. A plurality of heating sources are installed in the inner space of the cooktop part 200. The food or container containing the food may be heated by radiant heat transmitted from the plurality of heating sources to cook the food.

The oven part 300 has an approximately rectangular parallelepiped shape on the whole. A cavity (not shown) providing a space in which the food is cooked is defined in an inner space thereof. The inner space of the cavity is heated by radiant heat and conduction heat applied from the plurality of heating sources disposed outside the cavity to cook the food.

The cavity has the inner space and a rectangular parallelepiped shape with an opened front side. A food to be cooked or the cooked food may be accessible between the inner and outer spaces of the cavity through the opened front side. An oven door 310 for selectively opening or closing the opened front side of the cavity is rotatably disposed on a front surface of the oven part 300.

The oven door 310 has a square plate shape with a predetermined thickness. The front surface of the oven door 310 may be transparent on the whole to confirm a cooking state of the food received in the inner space of the cavity or a state of the inner space of the cavity.

Alternatively, the oven door 310 may have a transparent central portion to confirm the inner space of the cavity.

A door handle 320 grasped by the user when the user rotates the oven door 310 is disposed on a front surface of the oven door 310 to easily rotate the oven door 310. The door handle 320 may be recessed backward so that the user easily grasps the door handle 320. Alternatively, the door handle 320 may protrude forward from the front surface of the oven door 320.

That is, if the door handle 320 has a shape which is easily grasped by the user when the oven door 310 is rotated, the door handle 320 may have any shape. Since the cavity may provide a space in which the food is cooked therein, the cavity may have any shape if the cavity provides a space capable of cooking the food.

Also, the drawer part (not shown) has a rectangular parallelepiped shape with an opened front side. The heating sources for heating the inner space of the drawer part are disposed under the drawer part or on a bottom surface of the drawer part. The heating sources may be provided in plurality and also have various shapes.

Since the heating sources disposed in the drawer part heat the inner space of the drawer part, each of the heating sources may have various shapes.

The drawer part may be slidably disposed forward and backward so that the user takes the food or the container containing the food into the inner space to cook the food after the drawer part is slid forward by the user. A drawer handle grasped by the user when the user slides the drawer part is disposed on the front surface of the drawer part.

A top surface of the cooktop part 200 is defined by the top plate 210. The top plate 210 has a square plate shape with a predetermined thickness. Also, the top plate 210 may be formed of a glass of a ceramic material having high heat resistance.

A position of each of the heating sources may be displayed on the top surface of the top plate 210 so that the user recognizes the position of the heating source heating the food or container containing the food which is disposed on the top surface of the top plate 210.

This is done for a reason in which the user locates the food or container containing the food at an accurate position.

A control part 400 for controlling an operation of the main body 100 by the user is disposed on the front surface of the cooktop part 200. A plurality of electric components are mounted in an inner space of the control part 400 to operate the cooktop part 200 and the oven part 300. The operations of the cooktop part 200 and the oven part 300 may be controlled by the electric components.

A manipulation panel 410 for directly manipulating the operations of the cooktop part 200 and the oven part 300 is disposed on a front side of the control part 400. The manipulation panel 410 has a plate shape with a predetermined thickness. An upper end of the manipulation panel 410 is rotatably coupled to an upper end of a front surface of the control part 400.

The manipulation panel 410 includes a burner selection panel for a top burner to be used in a plurality of top burners disposed on the cooktop part 200, a firepower adjustment panel 414 for adjusting a firepower of the top burner, and an additional function panel 416 for manipulating an additional function.

Here, other panels may be further provided to manipulate the cooktop part 200 and the oven part 300, thereby controlling the cooktop part 200 and the oven part 300. That is, an oven manipulation panel for manipulating the oven part 300 may be disposed on the manipulation panel 410 to control an operation of the oven part 300.

A display part 500 may be disposed on the front surface of the control part 400 or the top surface of the top plate 210 so that the user controls the operation of the oven part 300 and recognizes the controlled operation.

The display panel 500 may be realized as a touch panel. Thus, when the user presses a surface of the display part 500, user's selection may be recognized.

A connection port connected to an external storage device such as an USB memory may be further disposed on one surface of the control part 400 to allow the user to download and store external data. The connection port may be disposed on the front surface of a side surface of the control part 400 or disposed on one surface of the manipulation panel 410.

Hereinafter, the display part 500 will be described in detail with reference to the accompanying drawings.

When the user selects the manipulation panel 410 or the control part 400 detects that a food does not exist in the inner space of the cavity, the control part 400, as shown in FIG. 2, controls the display part 500 to allow the display part 500 to display the main screen.

In the main screen, an upper menu 510 is displayed on an upper end of the display part 500, and an additional function menu 520 for selecting additional items is disposed on an end of the upper menu 510.

In the additional function menu 520, a kind of sound signal outputted according to user's selection may be selected or an additional function for selecting a function for cancelling the current inputted function or a function for moving from the present state to a just previous state may be selected.

The additional function may be added by the user. This may be realized by downloading external data to store the external data through the control part 400.

Also, in the main screen, the user may directly search recipes on a lower end of the display part 500. A search/input menu 530 in which the user may directly input the recipes is displayed on a left end of the display part 500, and a bookmark menu 540 in which the user may select frequent cooking or preference cooking is displayed on a right end of the display part 500.

The upper menu 510 may be divided by each category. When a first input signal is inputted into the upper menu 510, a lower menu 550 may be displayed under the upper menu 510 in which the first input signal is inputted.

When a second input signal is inputted into the lower menu 550, a detailed menu of the lower menu 550 in which the second input signal is inputted is selected. Thus, the user may cook the food according to the detailed menu.

Here, the user may press the upper menu 510 to generate the first input signal. Also, the user may press the lower menu 550 to generate the second input signal.

The upper menu 510 may display cooking by each category. This category may include cooking enable by time. That is, the lower menu 550 is displayed under the upper menu 510. Here, the lower menu 550 includes cooking enable by time, i.e., cooking enable at the shortest time from the present time and/or cooking enable at a predetermined time.

Also, the upper menu 510 displays cooking by each category. This category may include cooking enable by ingredient. That is, the lower menu 550 is displayed under the upper menu 510. Here, the lower menu 550 includes cooking enable by ingredient, i.e., cooking enable through the ingredients stored by the user or cooking enable through selected ingredients.

In detail, an upper menu 510 that is expressed as “By Ingredient” is expressed on the upper menu 510 in a button shape. When the user presses the upper menu 510 expressed in the button shape to generate the first input signal, the first input signal is transmitted into a MICOM mounted in the inner space of the control part 400.

The MICOM displays the lower menu 550 by ingredient according to the first input signal so that the user selects the ingredients displayed under the upper menu 510. Here, “poultry” such as chicken and turkey, “meat”, “fish”, “vegetable”, and “pasta” may be expressed on the lower menu 550.

Also, the user may download the external data to store the date, thereby adding, modifying, or supplementing the upper menu 510 or the lower menu 550.

Also, the upper menu 510 may include cooking enable by course. That is, a menu enable by course, i.e., a menu enable according to an eating order of the user may be expressed on the lower menu 550 displayed under the upper menu 550.

In detail, an upper menu 510 that is expressed as “By Course” is expressed on the upper menu 510 in a button shape. When the user presses the upper menu 510 expressed in the button shape to generate the first input signal, the first input signal is transmitted into the MICOM mounted in the inner space of the control part 400.

The MICOM displays the lower menu 550 according to the first input signal so that the user selects the course displayed under the upper menu 510. Here, “appetizers”, “mains”, “desserts”, and “sides” may be expressed on the lower menu 550.

Also, the upper menu 510 may include cooking enable by function. That is, a menu enable by function, i.e., a menu enable according to cooking functions may be expressed on the lower menu 550 displayed under the upper menu 550.

In detail, an upper menu 510 that is expressed as “By Function” is expressed on the upper menu 510 in a button shape. When the user presses the upper menu 510 expressed in the button shape to generate the first input signal, the first input signal is transmitted into a MICOM.

The MICOM displays the lower menu 550 according to the first input signal so that the user selects the functions displayed under the upper menu 510. Here, “bakes”, “roast”, “broil”, and “convection” may be expressed on the lower menu 550.

Also, the upper menu 510 may include cooking enable by occasion. That is, a menu enable by occasion, i.e., a menu enable according to user's occasion may be expressed on the lower menu 550 displayed under the upper menu 550.

In detail, an upper menu 510 that is expressed as “By Occasion” is expressed on the upper menu 510 in a button shape. When the user presses the upper menu 510 expressed in the button shape to generate the first input signal, the first input signal is transmitted into a MICOM.

The MICOM displays the lower menu 550 according to the first input signal so that the user selects the occasions displayed under the upper menu 510. Here, “quick & easy”, “healthy eating”, “gourmet meals”, “holiday”, “parties”, and “in season” may be expressed on the lower menu 550.

Also, the upper menu 510 may include cooking enable by cuisine. That is, a menu enable by cuisine, i.e., a menu enable adequate for user's taste, e.g., menu such as location, country, and vegetarian may be expressed on the lower menu 550 displayed under the upper menu 550.

In detail, an upper menu 510 that is expressed as “By Cuisine” is expressed on the upper menu 510 in a button shape. When the user presses the upper menu 510 expressed in the button shape to generate the first input signal, the first input signal is transmitted into a MICOM.

The MICOM displays the lower menu 550 according to the first input signal so that the user selects the cuisine displayed under the upper menu 510. Here, “Asian”, “French”, “Italian”, “Mexican”, and “vegetarian” may be expressed on the lower menu 550.

Also, cooking by each category, e.g., cooking enable by weather, day of the week, and user's feeling may be expressed on the lower menu 550 displayed under the upper menu 550.

Hereinafter, a process for expressing the search/input menu 530 in which the user directly searches recipes or cooking will be described in detail with reference to FIG. 4.

When the user presses the search/input menu 530 on the main screen to generate the first input signal, the first input signal is transmitted into the MICOM. The MICOM receiving the first input signal displays a screen as shown in FIG. 4.

A selection window 531 for selecting the course is disposed on a left portion of the search/input menu 530. A selection display window 532 for displaying the course selected by the user is disposed on a left portion of the selection window 531. A direction selection button 533 for selecting cooking in a vertical direction is disposed at a right portion of the selection display window 532.

Thus, when the user presses an up/down direction button of the direction selection button 533, the course selected by the pressing is displayed on the selection display window 532. Here, when the user presses an input button 538 displayed on an upper end of a right side of the screen of the search/input menu 530, a simultaneous cooking window 534 expressed at a left side of the selection window 531 may be inputted.

The input button 538 is expressed as “Find” in a button shape. Also, a movement button 539 for input cancel or movement into a previous process is disposed at a right side of the input button 538.

A cooking kind window 535 for displaying the cooking selected by the user is disposed at a left portion within the simultaneous cooking window 534. The direction selection button 533 for moving the menu of the cooking kind window 535 in the vertical direction is disposed at a right side of the cooking kind window 535.

Thus, when the user presses the up/down direction of the direction selection button 533, a kind of cooking is displayed on the cooking kind window 535 for displaying the cooking selected by the pressing. Here, when the user presses the input button 538 displayed on a right side of the upper end of the screen of the search/input menu 530, a time input window 537 displayed on a right side of the simultaneous cooking window 534 may be inputted.

A time window 538 for displaying the menu selected by the user is disposed on an inner left portion of the time input window 537. The direction selection button 533 for moving a time in up/down direction is disposed at a right side of the time window 538.

Thus, when the user presses the up/down direction of the direction selection button 533, the time window 538 for displaying the time selected by the pressing is displayed. Here, when the user presses the input button 538 displayed on the right side of the upper end of the screen of the search/input menu 530, the search and cooking setting may be finished to perform the cooking.

Hereinafter, a process for expressing the bookmark menu 540 in which the user may select frequent cooking or preference cooking will be described in detail with reference to FIG. 5.

When the user presses the bookmark menu 540 on the main screen to generate the first input signal, the first input signal is transmitted into the MICOM. The MICOM receiving the first input signal displays a screen as shown in FIG. 5.

The bookmark menu 540 may be expressed as a plurality of icons in which characteristics are expressed as diagram. Cooking such as fish cooking 541, meat cooking 542, baked cooking 543, bread cooking 545, chocolate cooking 546, and lasagna cooking 547 may be expressed as diagram to form the icons. The bookmark menu 540 may be added by downloading the external data or the user presses an add/delete button 548 disposed at a right upper portion of the screen to add and delete icons from the data stored in the MICOM.

Also, a cancel/movement button 549 for cancelling the input or moving a previous process is disposed at a right side of the add/delete button 548.

Referring to FIG. 6, when the user selects an upper menu 510 of “By Time” on the upper menu 510, cooking enable at the shortest time or cooking enable at a predetermined time is displayed on the lower menu 550. When the user presses the lower menu 550, the display part 500 may be expressed as the screen as shown in FIG. 6.

In detail, when the user selects the lower menu 550 to press the selected lower menu 550, the first input signal is generated. The first input signal is transmitted into the MICOM. The MICOM receiving the first input signal controls the display part 500 to display a screen as shown in FIG. 6.

The present cooking temperature and cooking remaining time are displayed on a central portion of the display part 500.

The present time and completion expectation time are displayed on an upper portion of the display part 500. Here, a graph is displayed under the portion at which the time is displayed. A kind of heating is displayed on the graph.

That is, as shown in FIG. 6, the present time is at 16:45, the radiant heat is applied at 17:30. Thereafter, the conduction heat is applied to complete the cooking. Also, it is seen that the cooking completion expectation time is at 16:00. Also, it is seen that the remaining time is at 75 minutes.

Hereinafter, an operation of the cooking appliance according to an embodiment will be described.

First, a first process for determining whether a food exists or detecting a signal according to user's selection is performed. If the food does not exist or the user's selection is detected in the first process, a second process for expressing the upper menu by category is performed.

Here, the user presses the upper menu 510 to generate the first input signal in the second process. The first input signal is transmitted into the MICOM. The display part 500 receiving the first input signal displays the lower menu 550 corresponding to a lower side of the selected upper menu 510 to perform a third process.

During the third process, the lower menu 550 is displayed on the display part 500. The user presses the lower menu 550 to generate a second input signal.

When the user presses the lower menu 550 to generate the second input signal, the second input signal is transmitted into the MICOM. The MICOM receiving the second input signal may be operated according to the user's selection to cook the food.

In the cooking appliance and the control method thereof according to the embodiment, the guide function for guiding the user's selection may be added. Thus, since the user selects the cooking by the guide function, the cooking appliance may be easily utilized.

In the cooking appliance and the control method thereof according to the embodiment, user's cooking selection may be varied. Also, the frequent cooking or preference cooking may be easily selected. In addition, the user may directly input the recipe to cook the food according to the inputted recipe.

Also, cooking adequate for user's feeling or state, tastes, weather desired for eating the cooked food, kinds of cooking, and cooking course may be guided to improve user's cooking selection range.

Also, the user's convenience may be maximized by the cooking guide function to reduce the cooking time.

Furthermore, the menu may be selected to obtain an adequate cooking according to the selected menu. Therefore, various cooking methods may be enable.

As described above, in the cooking appliance according to the embodiment, cooking enable for the user may be guided to allow the user to easily select the cooking.

Also, the food may be cooked using a recipe adequate for the surrounding environment or user's state.

Thus, the convenience of use of the cooking appliance may be maximized.

The cooking appliance according to the embodiment may be utilized in the production industry and distribution industry for producing and selling the cooking appliance.

Also, since foods different from each other are cooked using the various recipes at the same time, the cooking appliance may be available for the food industry or food service industry.

Also, since the various tastes of the user are satisfied, the cooking appliance may be available to the food industry or food service industry.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1.-27. (canceled)

28. A method of controlling a cooking appliance, the method comprising:
a first process for determining whether a food exists or detecting a signal by user's selection;
a second process for expressing an upper menu by category when the food does not exist or the user's selection is detected in the first process;
a third process in which the upper menu expressed in the second process expresses a lower menu by upper menu according to a first input signal;
a fourth process in which the lower menu expressed in the third process express a cooking progress according to a second input signal.

29. The method according to claim 28, wherein the category comprises cooking enable by time.

30. The method according to claim 29, wherein a cooking menu enable within a predetermined time is expressed in the lower menu in the cooking enable by time.

31. The method according to claim 29, wherein a cooking menu enable within a preset time is expressed in the lower menu in the cooking enable by time.

32. The method according to claim 28, wherein the category comprises cooking enable by ingredient.

33. The method according to claim 32, wherein an ingredient stored by the user is expressed in the lower menu in the cooking enable by ingredient.

34. The method according to claim 32, wherein the lower menu comprising poultry, fish, meat, vegetable, and pasta is expressed in the cooking enable by ingredient.

35. The method according to claim 28, wherein the category comprises cooking enable by course.

36. The method according to claim 35, wherein the lower menu comprising appetizers, mains, and desserts is expressed in the cooking enable by course.

37. The method according to claim 35, wherein the lower menu comprising sides is expressed in the cooking enable by course.

38. The method according to claim 28, wherein the category comprises cooking enable by function.

39. The method according to claim 38, wherein the lower menu comprising bakes, roast, broil, and convection is expressed in the cooking enable by function.

40. The method according to claim 28, wherein the category comprises cooking enable by occasion.

41. The method according to claim 40, wherein the lower menu comprising quick & easy, healthy eating, gourmet meals, holiday, parties, and in season is expressed in the cooking enable by occasion.

42. The method according to claim 28, wherein the category comprises cooking enable by cuisine.

43. The method according to claim 28, wherein the lower menu comprising country or location is expressed in the cooking enable by cuisine.

44. The method according to claim 28, wherein the category comprises cooking enable by weather, day of the week, and user's feeling.
